(19) United States
(12) Patent Application Publication
(10) Pub. No.: US 2025/0214274 A1
(43) Pub. Date: Jul. 3, 2025

(54) WOOD-MACHINING DEVICE HAVING A MACHINING GANTRY

(71) Applicants: Holzbau Unterrainer GmbH, Ainet (AT); MASCHINENBAU UNTERLERCHER GMBH, Hopfgarten in Defereggen (AT)

(72) Inventor: Leonhard UNTERRAINER, Thurn (AT)

(21) Appl. No.: 18/844,128

(22) PCT Filed: Mar. 6, 2023
(86) PCT No.: PCT/AT2023/000001

§ 371 Date: Sep. 5, 2024

(30) Foreign Application Priority Data
Mar. 10, 2022 (AT) A 64/2022

(51) Int. Cl. B27B 15/06; B27B 29/04

(52) U.S. Cl. CPC B27B 15/06; B27B 29/04

(57) ABSTRACT

A wood-machining device for machining round wood oriented in a longitudinal direction of the wood-machining device includes: a machine frame; a machining gantry mounted on the machine frame so as to move at least in the longitudinal direction; a holding device disposed on the machine frame for holding the round wood on the machine frame; a trimming device disposed on the machining gantry for trimming the round wood, the trimming device having at least one milling head; a cutting device disposed on the machining gantry for cutting the round wood, the cutting device having at least one saw, which, more particularly, is oriented horizontally; and a splitting device disposed on the machining gantry for splitting the round wood, the splitting device having at least one saw, which, more particularly, is oriented vertically.

The present invention concerns a wood-machining device for machining round wood aligned along a longitudinal direction of the wood-machining device, comprising a machine frame, a machining gantry mounted movably on the machine frame at least in the longitudinal direction, and a holding device arranged on the machine frame for holding the round wood on the machine frame. Moreover, the present invention concerns a wood-machining system comprising such a wood-machining device and a method for machining round wood.

Examples for wood-machining devices are disclosed in the documents WO 2018/190731 A1, U.S. Pat. No. 5,806,401, ES 2 382 858 A1, U.S. Pat. No. 5,109,899, WO 2020/079513 A1, CA 2,300,037 A1 and US 2019/0047170 A1.

From time immemorial, wood is used in various ways as a raw material for the production of items. The processing has developed constantly. Nowadays, the trees are cut with big machines and are processed immediately to round wood. This round wood is then transported with trucks to sawmills where the desired wooden boards are processed by debarking, trimming, cutting and splitting. In such sawmills, mostly big machines are used which conduct one of the processing steps each.

Such sawmills have several large disadvantages: The sawmills have a huge land requirement because a lot of wood must be put into interim storage after the various processing steps. There is a lot of transport effort because the processed wood has to be transported between the individual stations. The personnel effort is high because many different machines and means of transport have to be operated separately. Finally, it has become clear in recent months that sawmills have a certain monopoly position and can therefore dictate the price of cut boards at will when there is a lack of raw materials. This results in incalculable price risks for timber construction companies and the end consumer.

Therefore, the object of the present invention is to provide an improved wood-machining device. In particular, the disadvantages listed above should be eliminated. Above all, the wood-machining device should enable the production of cut wooden boards in a space-saving, efficient and quick manner and, if possible, independent of sawmills.

This is achieved by a wood machining device with the features of claim 1. According to the invention, it is provided that the wood-machining device comprises a trimming device arranged on the machining gantry for trimming the round wood, the trimming device having at least one milling head. In addition, the wood-machining device comprises a cutting device arranged on the machining gantry for cutting the round wood, the cutting device having at least one, in particular horizontally oriented, saw. Finally, the wood-machining device comprises a splitting device arranged on the machining gantry for splitting the round wood, the splitting device having at least one, in particular vertically oriented, saw.

The wood-machining device therefore has a machining gantry, the trimming device, the cutting device and the splitting device being arranged on this one machining gantry. This means that the processed wood no longer has to be laboriously transported back and forth between the individual processing stations and temporarily stored, but at least three processing steps can be carried out in a single processing portal.

In other words, the round wood remains continuously clamped to the same machine frame via the holding device, while the trimming, cutting and splitting of the entire round wood into the individual wooden boards is carried out completely.

The present invention results in a largely automated and labour-saving production option for wooden boards directly from round wood.

Preferred embodiments of the present invention are defined in the dependent claims.

In order to enable automation, preferably a first scanning device for scanning the round wood is provided.

According to a preferred embodiment it is provided, that the dimensions of the round wood can be detected with the first scanning device. In particular, the (minimum) diameter of the round wood is recorded with this first scanning device. The length of the log can also be recorded.

In order to enable safe, stable and consistent processing, it is preferably provided that the holding device has at least two holding jaws, wherein in a holding position the holding jaws contact the round wood, substantially centrally, on opposite end faces of the round wood.

It is particularly preferred that the round wood is rotatably mounted on the machine frame via the holding device, preferably in 90° increments.

In particular, the holding device has at least one drive motor, through which the rotation is carried out relative to the machine frame.

It should not be ruled out that the machining gantry is stationary, and the machine frame moves relative to the machining gantry. However, it is preferred that the machine frame is set up stationary—for example in a woodworking hall.

It is preferably provided that travel rails are arranged on the machine frame, the processing portal being mounted on the travel rails via rollers.

Particularly preferred, the travel rails run straight and parallel to the longitudinal direction of the wood-machining device.

The words “horizontal”, “vertical”, “front” and “rear” specified herein refer to the installed state of the wood-machining device when the round wood (and thus the longitudinal direction of the wood-machining device) is horizontally oriented during processing. If the wood-machining device is tilted or even vertically aligned when working, the reference of the words listed changes accordingly with the orientation of the wood-machining device.

The trimming device should be designed in such a way that the round wood can be trimmed quickly and easily. It is preferably provided that the at least one milling head of the trimming device is rotatable and—preferably at right angles to the longitudinal direction-mounted linearly displaceable on the machining gantry.

In addition, it can be provided that the at least one milling head is also mounted on the machining gantry so that it can be moved linearly in the horizontal direction. However, it is preferably provided that the holding device is mounted so that it can be moved linearly in the vertical direction relative to the machining gantry and its trimming device.

It can be provided that the trimming device comprises a drive motor arranged on the machining gantry for the at least one milling head of the trimming device.

According to a preferred exemplary embodiment, it is provided that the trimming device has at least three milling heads rotatable about a vertical axis of rotation. Preferably, an own drive motor is assigned to each milling head.

According to one embodiment, four milling heads can be provided. Specifically, two of the four milling heads can then be arranged in the longitudinal direction in front of the cutting device and two of the four milling heads can be arranged in the longitudinal direction behind the cutting device. With the two milling heads arranged on one side, it is possible—as with the splitting device—to carry out trimming (from both sides of a wooden board) depending on the direction of movement.

The cutting device should be designed so that cutting the round wood is possible. Preferably it is provided that the at least one saw of the cutting device, is mounted, preferably in the vertical direction, on the machining gantry so that it can be moved linearly. Alternatively (or additionally), it can be provided that the holding device is mounted so that it can be moved linearly relative to the machining gantry and its cutting device, preferably in the vertical direction. Thus, the different layers can be cut out of the round wood.

Further, it is provided that the at least one horizontally oriented saw of the cutting device is designed in the form of a circular saw or a band saw.

If the saw of the cutting device is designed as a band saw, it is preferably provided that this band saw has two cutting areas (oriented at right angles to the longitudinal axis) on both opposite longitudinal sides of the saw band of the band saw. This means that the round wood can be cut both when moving forwards and when moving backwards along the longitudinal axis.

Alternatively, it can be provided that the cutting device comprises two, horizontally aligned circular saws arranged one behind the other in the longitudinal direction, the two horizontally aligned circular saws-seen transversely to the longitudinal direction—are arranged offset next to each other. With these two circular saws it is possible for the round wood to be trimmed from both sides at the same time. It is therefore not necessary to use very large circular saws; it is sufficient that the radius of the circular saw is larger than the maximum radius of the round wood to be processed

Further, it is preferably provided that the cutting device comprises a drive motor arranged on the machining gantry for the at least one saw of the cutting device.

The splitting device should be designed in such a way that the logs can be split easily and quickly. It is preferably provided that the at least one vertically aligned saw of the splitting device is mounted on the machining gantry so that it can be rotated and, preferably in the horizontal direction, displaced linearly.

According to a preferred exemplary embodiment, it is provided that the at least one vertically aligned saw of the splitting device is designed in the form of a circular saw.

The size of this circular saw should be chosen so that the radius of the circular saw is larger than the maximum board thickness that can be produced.

Furthermore, it is preferably provided that the splitting device comprises a drive motor arranged on the machining gantry for the at least one saw of the splitting device.

For efficient processing, according to one exemplary embodiment it can be provided that the splitting device has two vertically aligned saws arranged one behind the other in the longitudinal direction, the two vertically aligned saws-seen transversely to the longitudinal direction-being arranged offset next to one another. This means that the round wood can even be split into three wooden boards lying next to each other.

Furthermore, it is preferably provided that one of the two vertically aligned saws of the splitting device is arranged in the longitudinal direction in front of the cutting device and the other of the two vertically aligned saws of the splitting device is arranged in the longitudinal direction behind the cutting device.

This makes it possible that only with the splitting device-which in the direction of movement of the machining gantry is situated before the cutting device—the round wood is split before cutting is carried out. As soon as the machining gantry has moved completely along the round wood and at least one wooden board has been cut down, the machining gantry moves in the opposite direction, with the other of the two vertically aligned saws then being “in front” of the cutting device in the direction of movement and splitting the round wood.

After trimming, cutting and splitting has been carried out, it is also important to transport and sort the wooden boards produced in this way as quickly as possible.

For this reason, a sorting unit is provided for sorting wooden boards cut from round wood.

In order to move the cut wooden board away from the remaining round wood, it is preferably provided that the sorting unit has a first, preferably stationary, transport device for transporting wooden boards cut from round wood

Per se, the first transport device can have a, preferably pincer-shaped, gripper. It is preferably provided that the first transport device is designed as a handling robot, preferably equipped with a vacuum suction device.

In order to guarantee compact and safe production, a, preferably lockable, housing is preferably provided for the machine frame including the machining gantry.

Particularly preferred, at least the first transport device is also arranged in the housing.

Further, it is preferably provided that the sorting unit has a second, preferably mobile, transport device for transporting, sorting and stacking the wooden boards. This means that the wooden boards can immediately be correctly assigned to a stack of (quasi) identically sized wooden boards.

In order to be able to carry out this sorting automatically, it is preferably provided that the wood-machining device comprises a second scanning device for scanning the wooden boards cut from the round wood.

It is preferably provided that the dimensions of the wooden boards and/or the board qualities can be detected with the second scanning device.

According to a preferred exemplary embodiment, it is provided that the holding device has at least two clamping elements separate from the holding jaws for holding the round wood via lateral surfaces.

This makes it possible for the holding device to reach around after cutting the side goods and hold the round wood (or the area left for the main goods) to the side so that the main goods can also be cut completely without the processed round wood being unclamped from the holding device.

For automation, it is particularly crucial that an open loop or closed loop control unit is provided for controlling or regulating the wood-machining device.

This open loop or closed loop control unit can be connected to an operating device or can be an integral part of such an operating device, so that an operator can operate and control the wood-machining device via a corresponding control program and operating menu. Such an operating device can have a screen and a keyboard, preferably a touchscreen.

It is preferably provided that a plurality of round wood cut patterns are stored in a memory of the open loop or closed loop control unit, each round wood cut pattern corresponds to a specific diameter or dimension of the round wood detected by the first scanning device. This makes it possible to fit the round wood cut pattern ideally into the actual dimensions of the round wood at hand. The round wood cut pattern should be designed or selected in such a way that there is as little waste as possible and that the quality of the individual wooden boards is as high as possible. There can be an entire library of different round wood sectional images stored.

Particularly preferred it is provided that the machining gantry and the devices arranged on the processing portal trimming device, cutting device, splitting device and holding device can be moved and operated depending on the round wood cut pattern corresponding to the detected diameter or dimension.

This means that trimming, cutting and splitting can be carried out fully automatically and quickly with a single processing portal.

Protection is also sought for a wood-machining system with a wood-machining device according to the invention.

In order to provide an efficient wood processing system which takes on all the tasks of a previous sawmill, it is preferably provided that the wood-machining system in addition to the woodworking device comprises a feed area for feeding round wood, and/or a debarking device for debarking the supplied round wood, and/or a wood shavings drying device, and/or a wood shavings compaction device, and/or a wood shavings container and/or a warehouse for stacks of boards. Of course, additional stations and devices can also be provided.

The object of the present invention is also achieved by a method according to claim 33. Such a method for machining round wood, which is aligned along a longitudinal direction of a wood-machining device, comprises the steps:
holding the round wood on a machine frame using a holding device,
moving a machining gantry in the longitudinal direction on the machine frame, the following steps being carried out during this movement of the machining gantry:
trimming the round wood by a trimming device arranged on the machining gantry, the trimming device comprising at least one milling head (the at least one milling head being rotatable and—preferably mounted at right angles to the longitudinal direction-linearly displaceable on the machining gantry)
cutting the round wood by a cutting device arranged on the machining gantry, the cutting device comprising at least one, in particular horizontally oriented, saw (the at least one horizontally aligned saw being rotatable and, preferably in the vertical direction, linearly displaceable on the processing portal), and
splitting the round wood by a splitting device arranged on the machining gantry, the splitting device comprising at least one, in particular vertically oriented, saw (the at least one vertically aligned saw being rotatable and, preferably in the horizontal direction, linearly displaceable on the machining gantry).

In this method, it can preferably be provided that the round wood is debarked in a debarking device before it is held over the holding device. The debarking device can also be arranged on the machine frame.

Further, it is preferably provided that during trimming the holding device holds the round wood via holding jaws engaging on the end faces and after the round wood has been completely trimmed, the holding device is changed in such a way that the holding device holds the round wood on its lateral surfaces via at least two clamping elements that are separate from the holding jaws. This means that the main good can be cut completely in one pass.

Further details and advantages of the present invention are described more fully hereinafter by means of the specific description with reference to the embodiments illustrated in the drawings, in which:

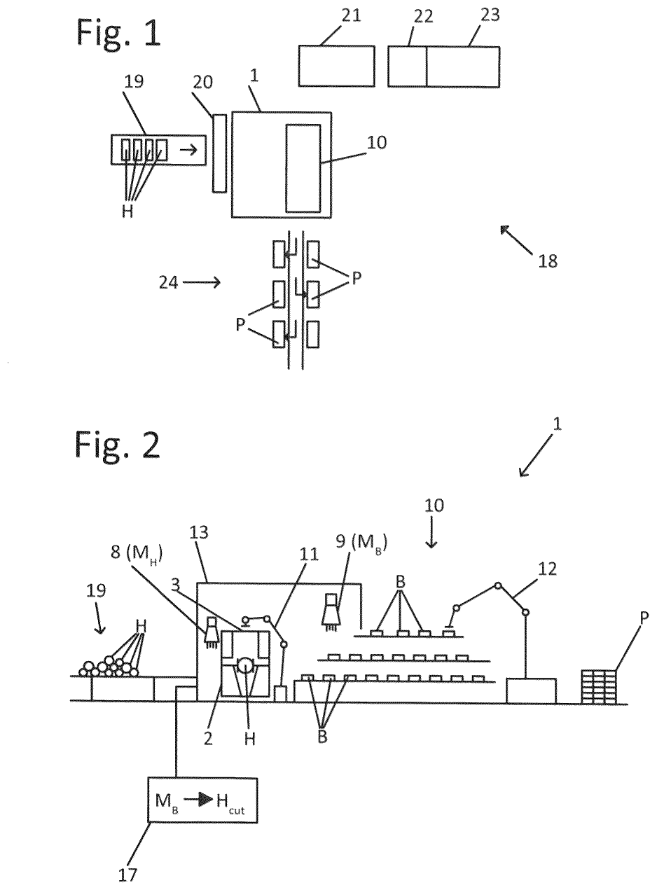

FIG. 1 shows a schematic top view of a wood-machining system with a wood-machining device,

FIG. 2 shows a schematic side view of a wood-machining system with a wood-machining device,

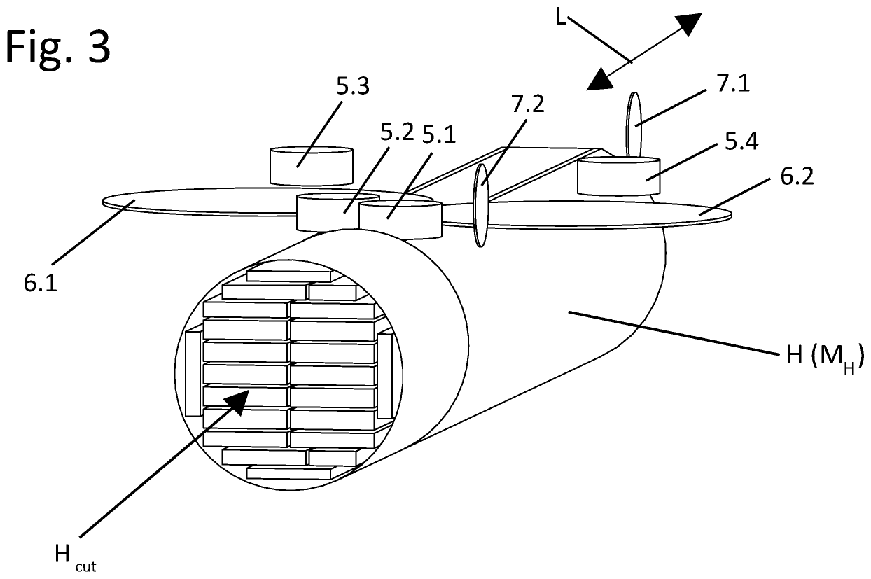

FIGS. 3-14 show in three-dimensional representations from diagonally below the various steps of machining the round wood with the wood-machining device,

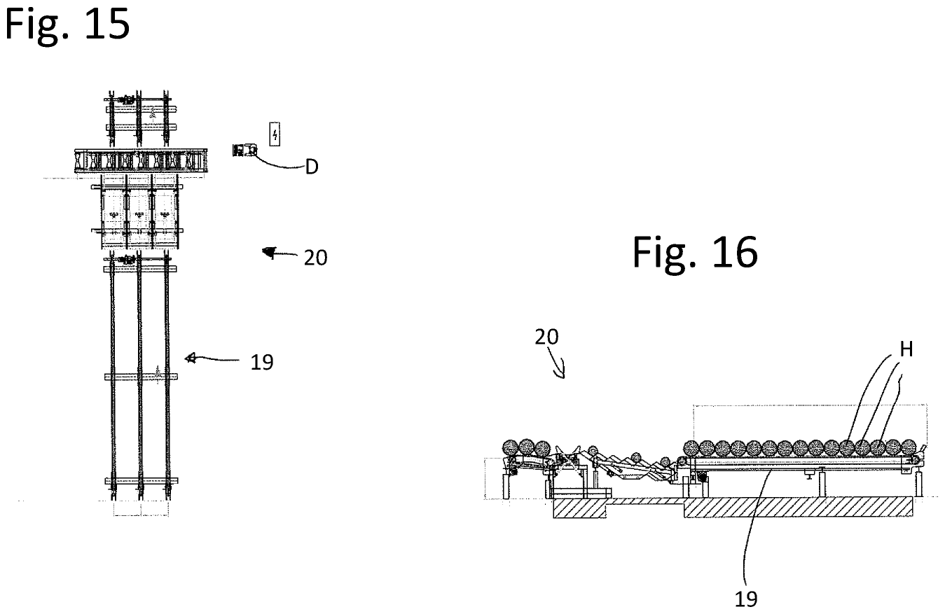

FIG. 15+16 show representations of a debarking device together with a feed area,

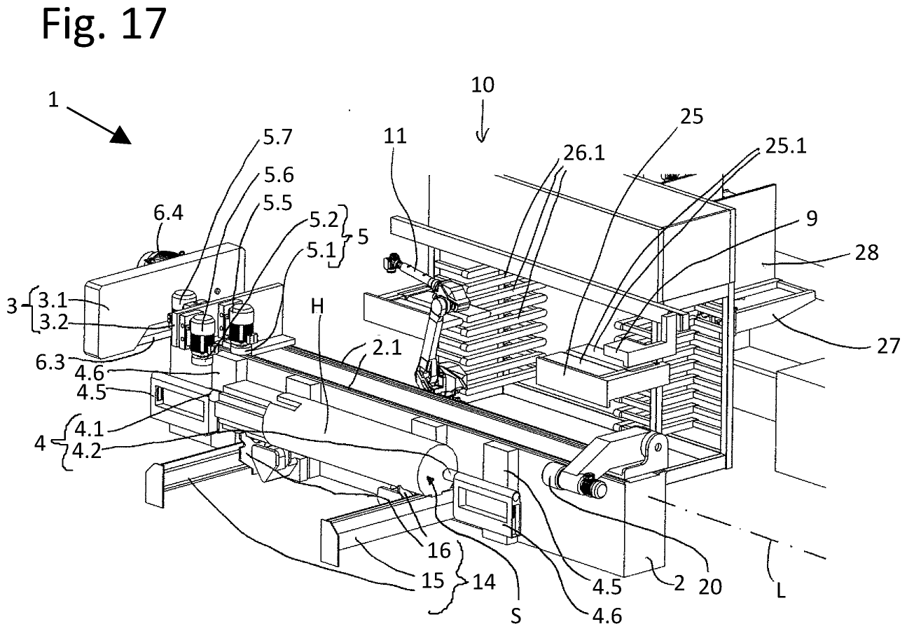

FIG. 17 shows a perspective view of a specific exemplary embodiment of the wood-machining device together with a sorting unit

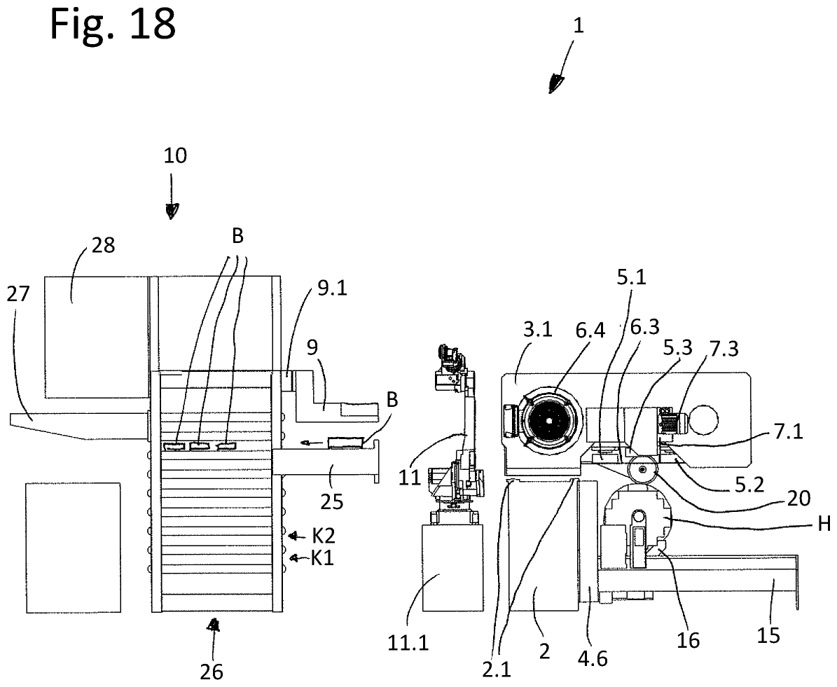

FIG. 18 shows a view of the wood-machining device together with the sorting unit and

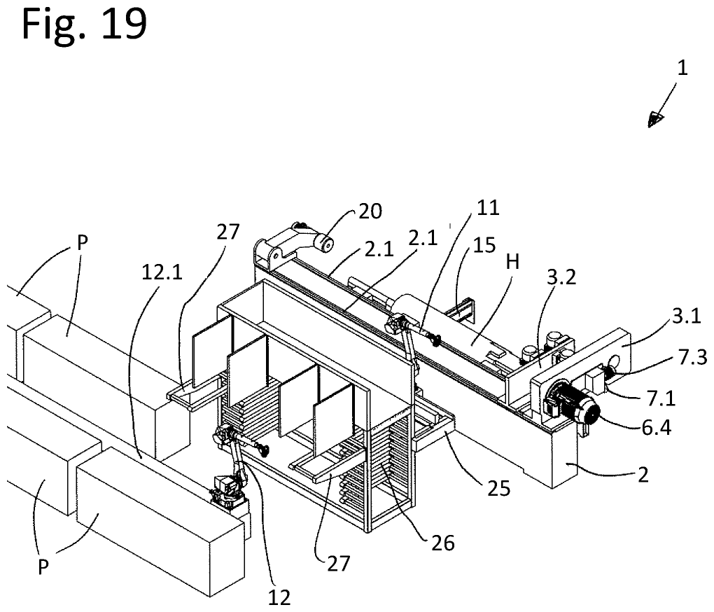

FIGS. 19-25 show various views of the wood-machining device together with the sorting unit in different positions.

A wood-machining system 18 is shown very schematically in FIG. 1. Such a wood-machining system 18 can be set up on the premises of a carpentry company, so it can be located practically anywhere. A preferred location-especially to keep transport distances short—is, for example, in the immediate vicinity of a production hall for prefabricated wooden components (wooden walls, etc.). Such a wood-machining system 18 only requires a floor area of approximately 500 m², whereby an annual output of approximately 25,000 cubic meters (in single-shift operation) can be achieved. For an output of approximately the same amount, common sawmills require an area of around 20,000 m².

In order to achieve all the basic functions and manufacturing processes as in a sawmill, the wood-machining system 18 includes the following components or stations in addition to the wood-machining device 1 (including the sorting unit 10):
a feed area 19 for feeding round wood H,
a debarking device 20 for debarking the supplied round wood H,
optionally a wood shavings drying device 21,
optionally a shavings compaction device 22,
optionally a shavings container 23 and/or
a warehouse 24 for stacks of boards P.

The arrangement of the individual stations is arbitrary, as long as efficient working is possible and should be adapted to the available space.

For the present invention, the wood-machining device 1 is now the essential component or station. In FIG. 2, this wood-machining device 1 is shown schematically in a side view.

The feed area 19 for round wood H is again shown in the left area. This can be designed like a known feed area 19, for example with rollers.

The wood-machining device 1 has a, preferably lockable, housing 13 for the machine frame 2 including the machining gantry 3. Before the round wood H is held in the machining gantry 3, it can pass through a first scanning device 8 for scanning the round wood H. With this first scanning device 8, the dimensions My of the round wood H can be recorded.

The wood-machining device 1 comprises a holding device 4, a trimming device 5, a cutting device 6 and a splitting device 7, these devices being discussed in detail later.

Furthermore, the wood-machining device 1 includes a sorting unit 10 for sorting the wooden boards B cut from the round wood H. This sorting unit 10 comprises a first transport device 11 (for example in the form of a handling robot with a vacuum suction cup) for transporting wooden boards B cut from round wood H.

The wood-machining device 1, preferably its sorting unit 10, can have a second scanning device 9 for scanning the wooden boards B cut from the round wood H. With this second scanning device 9, the dimensions MB of the wooden boards B and/or the board qualities can be detected.

The sorting unit 10 can also have a second, preferably mobile, transport device 12 for transporting, sorting and stacking the wooden boards B. These wooden boards B can then be stored on a board stack P in a warehouse 24.

An open loop or closed loop control 17 for controlling or regulating the wood-matching device 1 is provided. A large number of round wood cut patterns H_{cut} are stored in a memory of the open loop or closed loop control unit 17, each round wood cut pattern H_{cut} corresponding to a specific diameter or dimension MH of the round wood H detected by the first scanning device 8. The open loop or closed loop control unit 17 is signally connected to the scanning device 8. Depending on the design, the remaining components of the wood-machining device 1 can also be controlled or regulated via the open loop or closed loop control unit 17.

FIGS. 3 to 14 show a round wood H in a three-dimensional view diagonally from the front. Some components of the wood-machining device 1 are hidden, so that only the milling heads 5.1, 5.2, 5.3 and 5.4 of the trimming device 5, the saws 6.1 and 6.2 of the cutting device 6 and the saws 7.1 and 7.2 of the splitting device 7 are shown. A specific round wood cut pattern H_{cut} is schematically drawn in the round wood H, which is digitally fitted into the round wood H based on a previously carried out recording of the dimensions MH of the round wood H. Thus, FIGS. 3 to 14 only correspond to a kind of preliminary visualization of the form in which the individual wooden boards B should be cut out of the round wood H, which is still in one piece.

In FIG. 3 the first step of the machining process now takes place. For this purpose, the devices trimming device 5, cutting device 6 and splitting device 7, which are movably mounted on the machining gantry 3 (not shown), are moved in the longitudinal direction L along the machine frame 2 (not shown). This movement occurs from back to front, but of course it can also be done the other way around. The two milling heads 5.1 and 5.2 mill off the uppermost area of the round wood H. This causes the debarked tree to be milled flat.

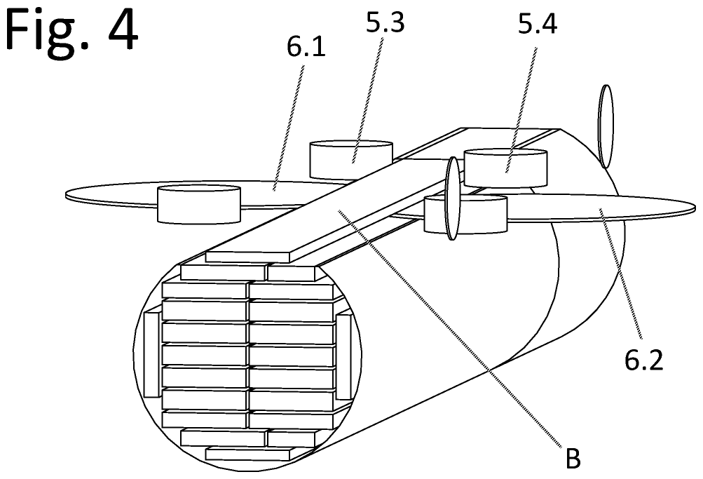

In FIG. 4, the first step has already been completed and the “top layer” has been completely milled away. Now, in the second step, the machining gantry 3, together with the devices 5, 6 and 7 arranged on it, moves backwards again.

Before the start of this backward movement, the milling heads 5.1 and 5.2 move away from each other or move at right angles to the longitudinal axis L relative to the machining gantry 3. On the other hand, the milling heads 5.3 and 5.4 carry out the opposite movement to one another. This is possible because the at least one milling head 5.1, 5.2, 5.3 and/or 5.4 of the trimming device 5 is mounted on the machining gantry 3 so that it can be rotated and linearly displaced (at least) in the horizontal direction at right angles to the longitudinal direction L.

Before the backward movement of the machining gantry 3, there is also a vertical relative movement between the devices 5, 6 and 7 and the round wood H. For this purpose, the devices 5, 6 and 7 can
either be moved vertically (downwards) relative to the machining gantry 3
or the entire machining gantry 3 can be moved vertically (downward) relative to the machine frame 2 including the round wood H
or the round wood H can be moved vertically (upwards) relative to the machining gantry 3.

The height adjustment as well as the horizontal adjustment of the individual processing elements (milling heads and saws) is carried out by the open loop or closed loop control unit 17 depending on the specified log cutting pattern H_{cut}. The position of the respective processing elements is adjusted before each new backward or forward movement of the machining gantry 3 along the machine frame 2.

When moving the trimming device 5 backwards along the round wood H, the milling heads 5.3 and 5.4, which are now located at the front and are closer together, trim the (new) top layer of the round wood H as shown in FIG. 4. The milling heads 5.3 and 5.4, thus, create the lateral surfaces of the top wooden board 4 in FIG. 4. At the same time, the saws 6.1 and 6.2 cut the round wood H so that the top wooden board B separates from the round wood H. The saws 6.1 and 6.2 therefore produce the lower horizontal surface of the topmost wooden board B in FIG. 4 and at the same time already the upper horizontal surface of the at least one underlying wooden board B.

After the machining gantry 3 has carried out the complete backward movement, the top wooden board B is separated from the remaining round wood H and can be picked up and transported further by the first transport device 11 of the sorting unit 10, not shown here.

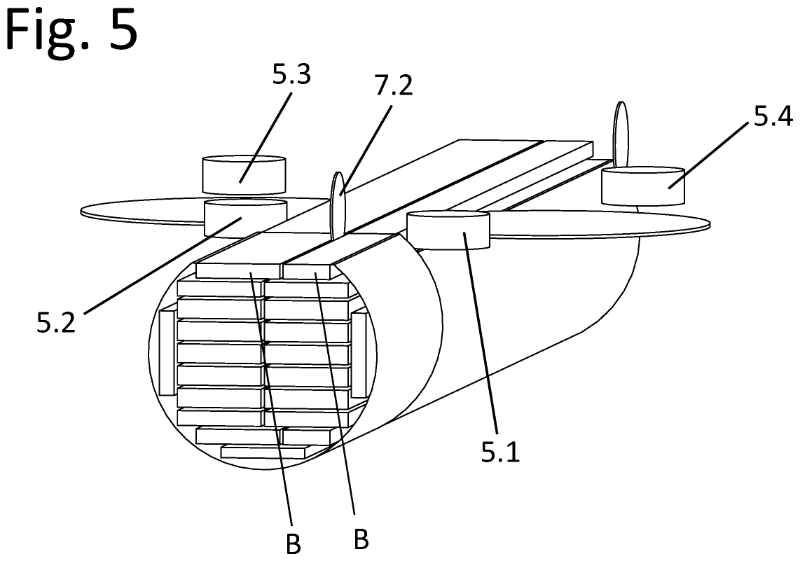

Before the forward movement shown in FIG. 5 is carried out, the processing elements are again shifted in the vertical direction and in the horizontal direction. The milling heads 5.1 and 5.2 are moved horizontally to each other, the milling heads 5.3 and 5.4 are moved away from each other and the vertically oriented saw 7.2 of the splitting device 7 is linearly displaced in the horizontal direction.

When the machining gantry 3 is moved forward as shown in FIG. 5, thus, two wooden boards B of different widths are cut out of what is now the top layer of the round wood H. The two milling heads 5.1 and 5.2 create the outer side surfaces of the wooden boards B, the saw 7.2 creates the two inner side surfaces of the wooden boards B and the saws 6.1 and 6.2 create the two lower horizontal surfaces as well as the upper horizontal surface of the next layer.

After the cut has been completed, the two wooden boards B are picked up again by the first transport device 11 and are transported for further processing.

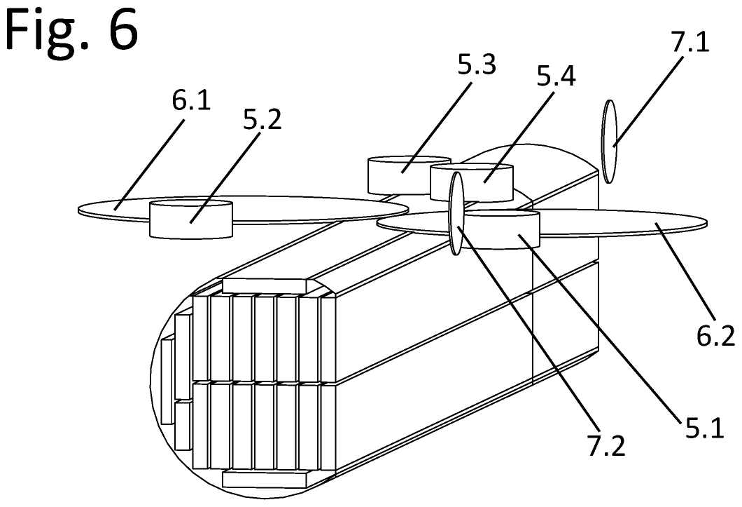

Before the processing according to FIG. 6 starts with a backward movement of the machining gantry 3, the round wood H is rotated by 90°—in this case to the right—using the holding device 4 (not shown here). As a result, the surface milled in the first steps lies on its side and is now aligned vertically.

In FIG. 6, the milling heads 5.3 and 5.4 have been moved towards each other again, the milling heads 5.1 and 5.2 are again far apart from one another and the vertical saw 7.2 of the splitting device 7 has been moved away from the round wood H again. As a result, the area of the round wood H that is now on top is milled flat by the milling heads 5.3 and 5.4 (and by the horizontal saws 6.1 and 6.2).

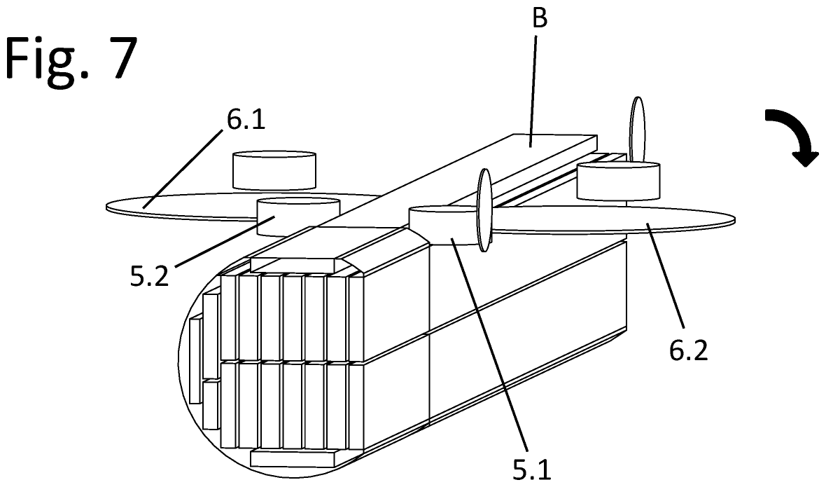

In FIG. 7, after the corresponding adjustment of the processing elements, the forward movement of the machining gantry 3 (not shown) takes place, so that-almost in the same way as in FIG. 4—a wooden board B is cut out from the round wood H.

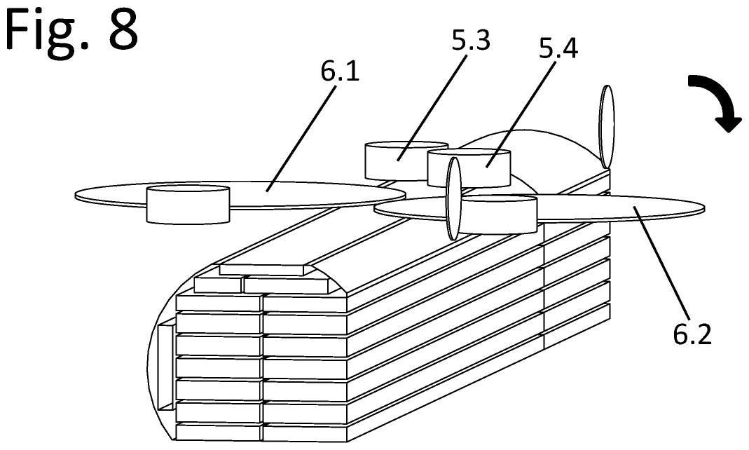

Before the backward movement of the processing portal 3 shown in FIG. 8, the round wood H is again rotated by 90° to the right and the processing elements are adjusted accordingly. In FIG. 8, the side of the round wood H that is now on top is then milled flat.

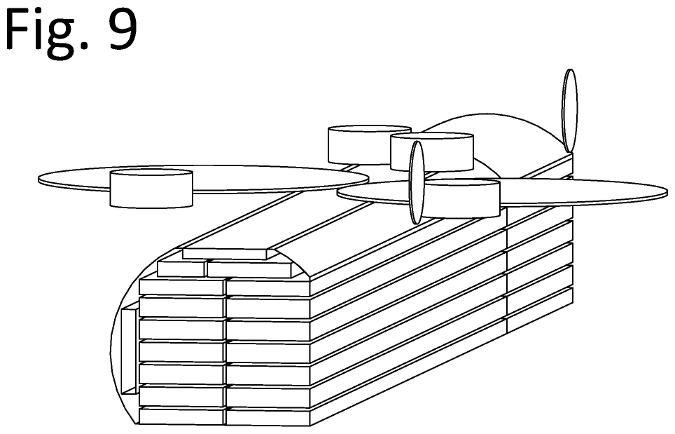

FIG. 9 is identical to FIG. 8.

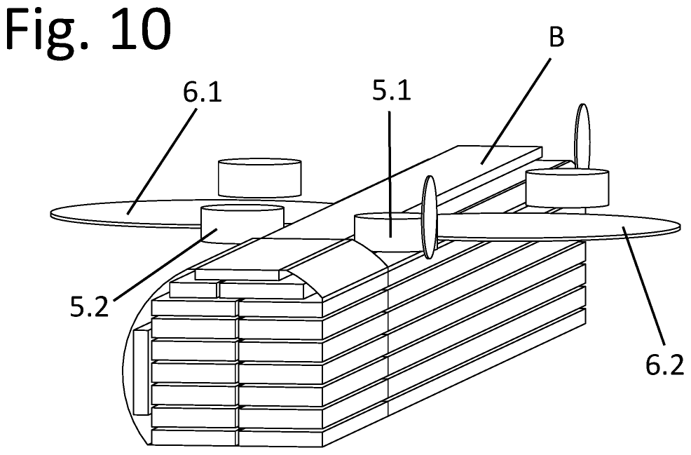

In FIG. 10—just like in FIG. 7—the top wooden board B is cut out from the round wood H.

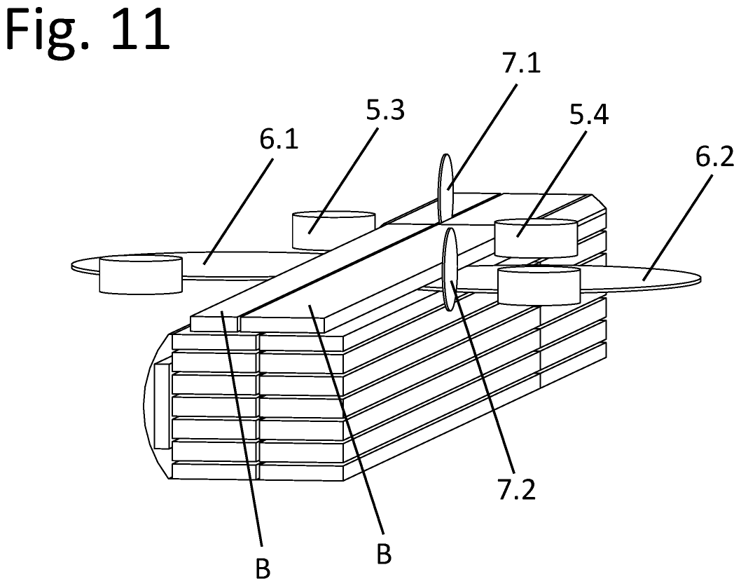

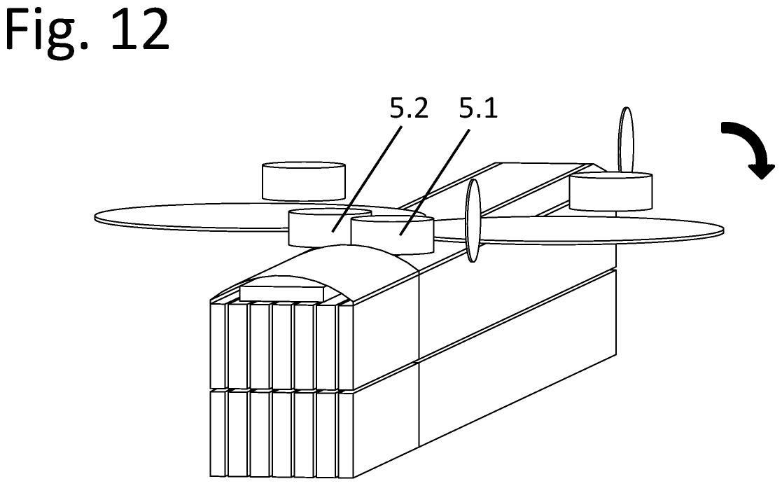

FIG. 11 essentially corresponds to FIG. 5, in which case the two wooden boards B are cut using the vertical saw 7.1 and the milling heads 5.3 and 5.4 when moving backwards.

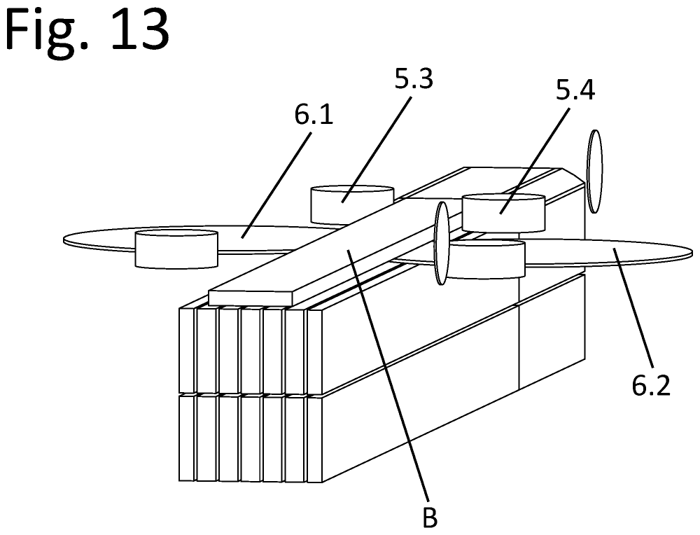

Before the forward movement according to FIG. 12 starts, the round wood H is moved again by 90° to the right via the holding device 4. The round wood H is milled flat on the upper side by the milling heads 5.1 and 5.2.

In FIG. 13, when moving backwards, a wooden board B—the so-called side goods—is cut out of the round wood according to the round wood cutting pattern H_{cut}.

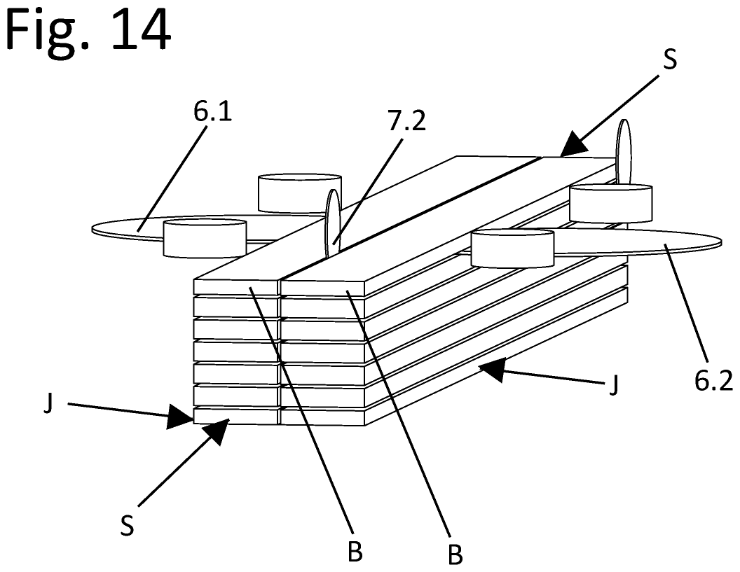

Finally, in FIG. 14, the individual wooden boards B are cut out of the remaining round wood H, layer by layer. Again, of course, the processing elements are adjusted accordingly for each layer in the vertical direction and, if necessary, in the horizontal direction before cutting.

Until the last processing step according to FIG. 14, the round wood H is held via the at least two holding jaws 4.1 and 4.2 (not shown here) of the holding device 4, the holding jaws 4.1 and 4.2 in a holding position essentially centrally contacting opposite end faces S of the round wood H. Before the position according to FIG. 14, a gripping takes place in such a way that at least two clamping elements 4.3 and 4.4, separate from the holding jaws 4.1 and 4.2, hold the round wood H over the lateral surfaces J.

A debarking device 20 is shown as an example in FIGS. 15 and 16. In FIG. 15 this is shown in a top view and in FIG. 16 in a longitudinal section. The round wood H is, for example, loaded from a truck (wood transporter) onto the feed area 19. From there the round wood H rolls to the debarking device 20. The debarking itself is not described in more detail because this is a process known to those skilled in the art. Debarking can be carried out and/or monitored by an operator. The debarked round woods H can then be scanned individually by the first scanning device 8.

In FIG. 17, the majority of the components of the wood-machining device 1 can be seen in a three-dimensional oblique view. The machine frame 2 is aligned along the longitudinal direction L.

A guide device 14 for feeding the round wood H is arranged on the machine frame 2. The guide device 14 comprises two horizontal supports 15, which are aligned essentially at right angles to the longitudinal axis L. Guide pieces 16, preferably V-shaped, are movably mounted on the supports 15. (The guide pieces 16 are preferably mounted so that they can move linearly in the horizontal direction at right angles to the longitudinal direction L along the supports 15.) In FIG. 17 it can be seen that a (partially already processed) round wood H rests on these two guide pieces 16 and already through the guide pieces 16 was moved towards the machine frame 2.

A holding device 4 for holding the round wood H on this machine frame 2 is arranged on the machine frame 2. The holding device 4 comprises at least two holding jaws 4.1, 4.2, with the holding jaws 4.1, 4.2 engaging essentially centrally on opposite end faces S of the round wood H in a holding position.

The two holding jaws 4.1 and 4.2 are each part of a so-called tailstock. A tailstock is used to support long workpieces (in this case the round wood H) using a centering point that engages in the front of the workpiece. A tailstock centering tip, thus, forms a holding jaw 4.1 or 4.2 respectively.

Specifically, a tailstock comprises a vertical travel rail 4.5 arranged on the machine frame 2, on which a carrier 4.6 is mounted so that it can move in the height direction. On the carrier 4.6, in turn, the centering tip together with the holding jaw 4.1 or 4.2 is movably mounted. Specifically, this centering tip can be moved in the longitudinal direction L relative to the carrier 4.6. The centering tips of the two tailstocks together with their holding jaws 4.1 and 4.2 can, therefore, move towards and away from each other. This allows the holding device 4 to hold round wood H of different lengths (larger distance between the holding jaws 4.1 and 4.2 from one another for long round wood H; shorter distance for shorter round wood H).

The holding device 4 (or each tailstock) comprises corresponding drive means for automatically carrying out the relative movements of the holding jaws 4.1 and 4.2 to the machine frame 2.

A machining gantry 3 is mounted on the machine frame 2 so that it can move in the longitudinal direction L. In the case shown in FIG. 17, the machining gantry 3 has two gantry parts 3.1 and 3.2 that can be moved together but also separately from one another.

Travel rails 2.1 are arranged on the machine frame 2. The machining gantry 3 can, for example, be movably mounted on the travel rails 2.1 via rollers.

The cutting device 6 for cutting the round wood H is arranged on the gantry part 3.1, the cutting device 6 having at least one (in this case horizontally oriented) saw 6.3 in the form of a band saw. The drive motor 6.4 for the band saw is also attached to the gantry part 3.1.

The splitting device 7 for splitting the round wood H is arranged on the gantry part 3.1. In the oblique view shown in FIG. 17, however, their essential components are covered by the portal part 3.1.

The trimming device 5 for trimming the round wood H is arranged on the gantry part 3.2. In the case shown, this trimming device 5 has three milling heads 5.1, 5.2 and 5.3 together with associated drive motors 5.5, 5.6 and 5.7.

Especially if no separate, upstream debarking device is provided, a (relatively small) independent debarking device 20 can also be movably mounted directly on the machine frame 2 for debarking the round wood H already clamped on the holding device 4.

In the background of FIG. 17, essential components of the sorting unit 10 are also shown, for example the first transport device 11 in the form of a handling robot equipped with a vacuum suction device.

FIG. 18 shows a side view of the wood-machining device 1 including the sorting unit 10. It is clearly visible that the gantry part 3.1 of the machining gantry 3 is mounted on the travel rails 2.1 of the machine frame 2.

The drive motor 6.4 for the saw 6.3 of the cutting device 6 is arranged on the gantry part 3.1.

The splitting device 7 has a vertically aligned saw 7.1, which is driven by the drive motor 7.3.

The milling heads 5.1, 5.2 and 5.3 of the trimming device 5 can also be seen. The debarking device 20 is also shown.

The carrier 4.6 for a tailstock is arranged on the machine frame 2. Furthermore, the support 15 and the guide pieces 16 are connected to the machine frame 2.

The first transport device 11 is mounted on an independent base 11.1 so that it can rotate at least about a vertical axis of rotation.

The sorting unit 10 comprises a second scanning device 9 for scanning the wooden boards B cut from the round wood H. The scanning device 9 is mounted so that it can move in the longitudinal direction L along the travel rail 9.1. For this purpose, a cut wooden board B is placed onto the assessment platform 25 by the first transport device 11. Then the scanning device 9 moves along the travel rail 9.1 and scans the wooden board B placed thereon. Depending on the recorded category of the wooden board B, the wooden board B is sorted into the sorting box 26. For this purpose, corresponding conveyor belts 25.1 and 26.1 are arranged on the assessment platform 25 and also in the sorting box 26. After the category has been recorded, the assessment platform 25 first moves in the height direction to the corresponding category K1, K2, etc. of the sorting box 26. Then the conveyor belts 25.1 and 26.1 begin to move and bring the wooden board B in the horizontal direction into the corresponding position of the sorting box. As soon as one layer is full of wooden boards B, these wooden boards B can be transported into the slat magazine 28 via the layer conveyor belt 27.

The components of the sorting unit 10 are shown equally in FIG. 18 and FIG. 17 and are partly relatively easy to recognize.

In FIG. 19 a view is shown obliquely from the rear. The majority of the components of the wood-machining device 1 can again be seen, with the same reference numbers designating the same parts, units or components. This FIG. 19 also shows the second transport device 12 (handling robot), which runs along the base 12.1 in the longitudinal direction L. With this second transport device 12, the wooden boards B can be put together into individual board stacks P, which can then be transported further by trucks or other means of transport.

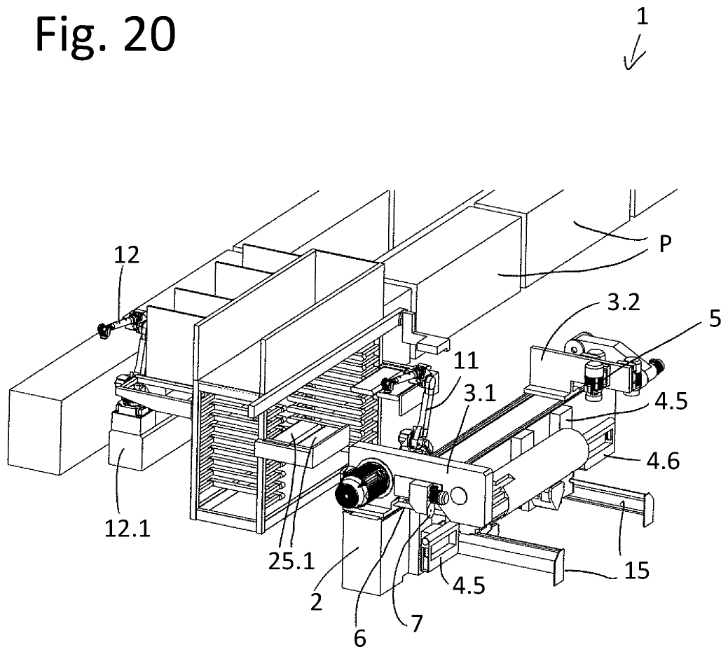

FIG. 20 again shows a 3D view of the wood-machining device 1 from a different direction. In contrast to the previous illustrations, the gantry part 3.2 has moved backwards along the machine frame 2 in order to trim the round wood H with the trimming device 5.

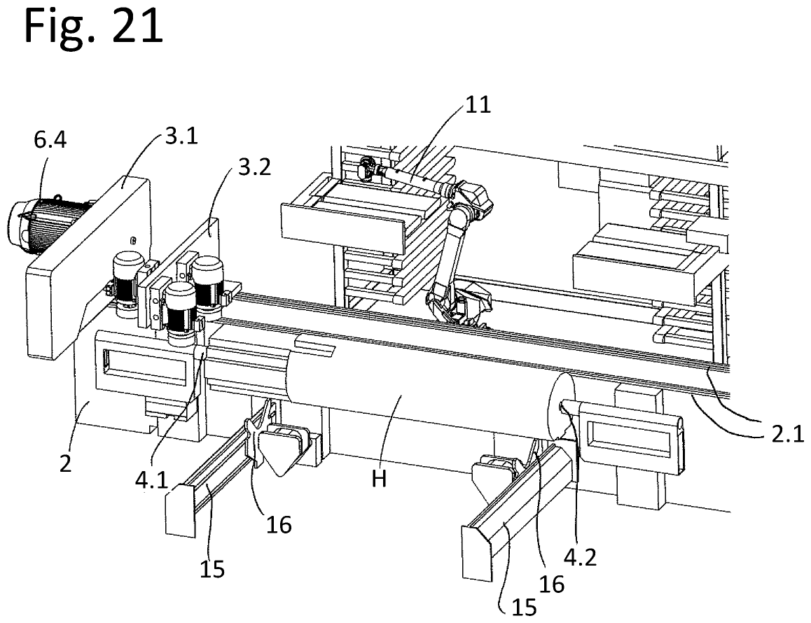

FIG. 21 shows the wood-machining device 1 before the start of this trimming process. Using the holding device 4 and its holding jaws 4.1 and 4.2, the round wood H is moved upwards by the supports 4.5 along the travel rails 4.6. As a result, the round wood H no longer rests in the V-shaped guide pieces 16 and can therefore be rotated by rotating the holding jaws 4.1 and 4.2 (for example by) 90°.

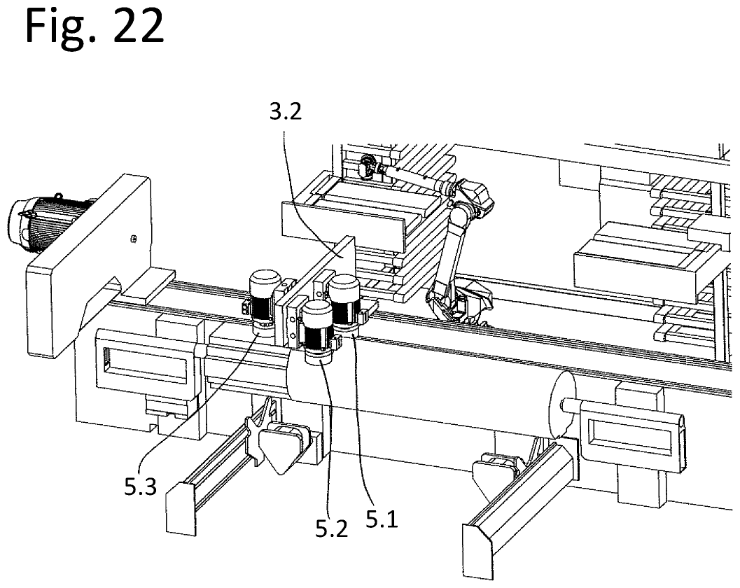

In FIG. 22, the gantry part 3.2 now moves along the machine frame 2 and trims the round wood H.

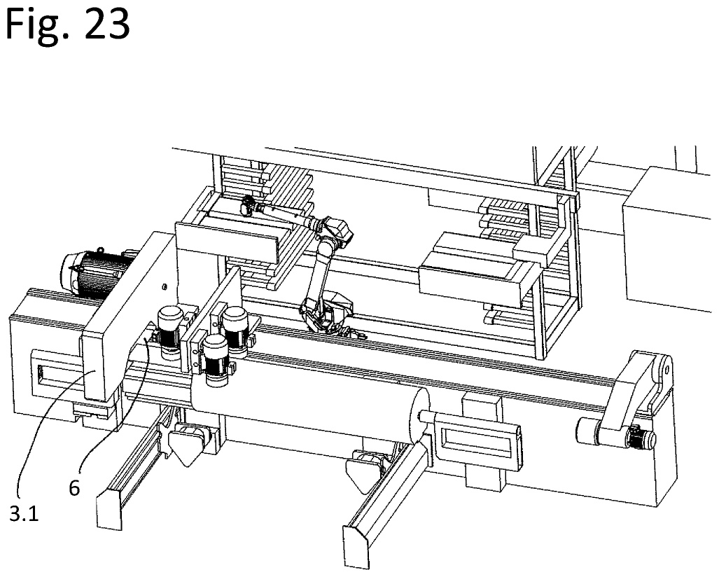

In FIG. 23, the gantry part 3.1 also moves along the machine frame 2, so that a wooden board B is cut from the round wood H by the cutting device 6.

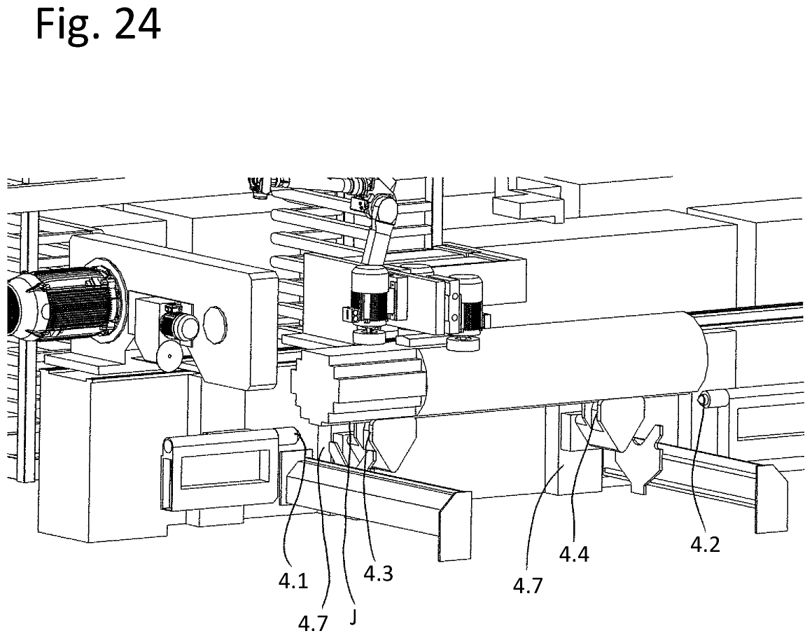

In FIG. 24, the round wood H is no longer held between the holding jaws 4.1 and 4.2. Rather, the round wood H is held here over lateral surfaces J via two clamping elements 4.3 and 4.4 that are separate from the holding jaws 4.1 and 4.2. These clamping elements 4.3 and 4.4 each have clamping jaws which can move towards one another in order to contact and thus hold an already trimmed lateral surface J from the rear and from the front. The entire clamping elements 4.3 and 4.4 can in turn be moved vertically along the travel rails 4.7.

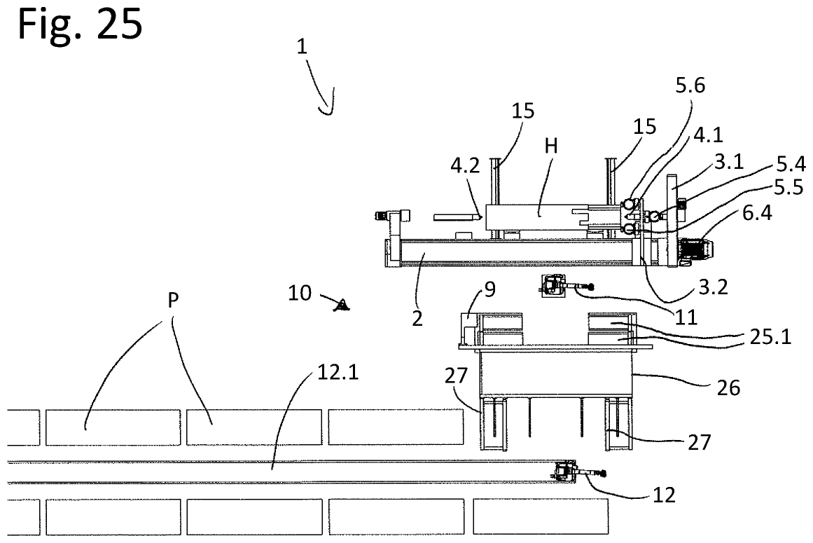

Finally, FIG. 25 shows a top view of the entire wood-machining device 1 including the sorting unit 10.

### LIST OF REFERENCE SYMBOLS

1 wood-machining device
2 machine frame
2.1 travel rails
3 machining gantry
3.1 gantry part
3.2 gantry part
4 Holding device
4.1 holding jaw
4.2 holding jaw
4.3 clamping elements
4.4 clamping elements
4.5 travel rail
4.6 carrier
4.7 travel rails
5 trimming device
5.1 milling head
5.2 milling head
5.3 milling head
5.4 milling head
5.5 drive motor
5.6 drive motor
5.7 drive motor
6 cutting device
6.1 saw in the form of a circular saw
6.2 saw in the form of a circular saw
6.3 saw in the form of a band saw
6.4 drive motor
7 splitting device
7.1 saw
7.2 saw
7.3 drive motor
8 first scanning device
9 second scanning device
9.1 travel rail
10 sorting unit
11 first transport device
11.1 base
12 second transport device
12.1 base
13 Housing
14 guide device
15 supports
16 guide pieces
17 open loop or closed loop control unit
18 wood-machining system
19 feed area
20 debarking device
21 wood shavings drying device
22 wood shavings compaction device
23 wood shavings container
24 warehouse for stacks of boards
25 assessment platform
25.1 conveyor belts of the assessment platform
26 sorting box
26.1 conveyor belts of the sorting box
27 layer conveyor belt
28 slat magazine
L longitudinal direction
H round wood
MH dimensions of the round wood H
MB dimensions of the wooden boards B
S end faces of the round wood H
B wooden boards
J lateral surfaces
H_{cut} round wood cut patterns
P stacks of boards
D user
K1, K2 category of the sorting box
Ainet, on Mar. 6, 2023

1. A wood-machining device for machining round wood aligned along a longitudinal direction of the wood-machining device, comprising:
a machine frame,
a machining gantry mounted movably on the machine frame at least in the longitudinal direction,
a holding device arranged on the machine frame for holding the round wood on the machine frame
a trimming device arranged on the machining gantry for trimming the round wood, the trimming device having at least one milling head
a cutting device arranged on the machining gantry for cutting the round wood, the cutting device having at least one, in particular horizontally oriented, saw, and
a splitting device arranged on the machining gantry for splitting the round wood, the splitting device having at least one, in particular vertically oriented, saw.

2. The wood-machining device for claim 1, further comprising a first scanning device for scanning the round wood.

3. The wood-machining device according to claim 2, wherein the dimensions of the round wood can be detected with the first scanning device.

4. The wood-machining device according to claim 1, wherein the holding device has at least two holding jaws, wherein in a holding position the holding jaws contact the round wood, substantially centrally, on opposite end faces of the round wood.

5. The wood-machining device according to claim 1, wherein the round wood is rotatably mounted on the machine frame via the holding device, preferably in 90° increments

6. The wood-machining device according to claim 1, wherein travel rails are arranged on the machine frame, the processing portal being mounted on the travel rails via rollers.

7. The wood-machining device according to claim 1, wherein the at least one milling head of the trimming device is rotatable and—preferably at right angles to the longitudinal direction—mounted linearly displaceable on the machining gantry.

8. The wood-machining device according to claim 1, wherein the trimming device comprises a drive motor arranged on the machining gantry for the at least one milling head of the trimming device.

9. The wood-machining device according to claim 1, wherein the trimming device has at least three milling heads rotatable about a vertical axis of rotation

10. The wood-machining device according to claim 1, wherein the at least one saw of the cutting device, is mounted, preferably in the vertical direction, on the machining gantry so that it can be moved linearly or that the holding device is mounted so that it can be moved linearly relative to the machining gantry and its cutting device, preferably in the vertical direction

11. The wood-machining device according to claim 1, wherein the at least one saw of the cutting device is in the form of a circular saw or a band saw.

12. The wood-machining device according to claim 11, wherein the band saw comprises two cutting areas, preferably aligned at right angles to the longitudinal axis, on opposite longitudinal sides of a saw band of the band saw.

13. The wood-machining device according to claim 11, wherein the cutting device comprises two, horizontally aligned circular saws arranged one behind the other in the longitudinal direction, the two horizontally aligned circular saws—seen transverse to the longitudinal direction—are arranged offset next to each other.

14. The wood-machining device according to claim 1, wherein the cutting device comprises a drive motor arranged on the machining gantry for the at least one saw of the cutting device.

15. The wood-machining device according to claim 1, wherein the at least one vertically aligned saw of the splitting device is mounted on the processing portal to allow the at least one vertically aligned saw to be rotated and, preferably in the horizontal direction, displaced linearly.

16. The wood-machining device according to claim 1, wherein the at least one vertically aligned saw of the splitting device is designed in the form of a circular saw

17. The wood-machining device according to claim 1, wherein the splitting device comprises a drive motor arranged on the machining gantry for the at least one saw of the splitting device.

18. The wood-machining device according to claim 1, wherein a sorting unit is provided for sorting wooden boards cut from the round wood.

19. The wood-machining device according to claim 18, wherein the sorting unit has a first transport device for transporting wooden boards cut from round wood.

20. The wood-machining device according to claim 19, wherein the first transport device is designed as a handling robot, preferably equipped with a vacuum suction device.

21. The wood-machining device according to claim 1, wherein a, preferably lockable, housing is provided for the machine frame including the machining gantry.

22. The wood-machining device according to claim 21, wherein at least the first transport device is arranged in the housing.

23. The wood-machining device according to claim 1, wherein the sorting unit has a second, preferably mobile, transport device for transporting, sorting and stacking the wooden boards.

24. The wood-machining device according to claim 1, wherein the wood-machining device, preferably its sorting unit, comprises a second scanning device for scanning the wooden boards cut from the round wood.

25. The wood-machining device according to claim 24, wherein the dimensions of the wooden boards and/or the board qualities can be detected with the second scanning device.

26. The wood-machining device according to claim 1, wherein the holding device has at least two clamping elements separate from the holding jaws for holding the round wood via lateral surfaces.

27. The wood-machining device according to claim 1, wherein a guide device for feeding the round wood is arranged on the machine frame, the guide device comprising two horizontal supports aligned substantially at right angles to the longitudinal axis and movably mounted, preferably V-shaped, guide pieces on the supports.

28. The wood-machining device according to claim 1, further comprising an open loop or closed loop control unit for controlling or regulating the wood-machining device.

29. The wood-machining device according to claim 28, wherein a plurality of round wood cut patterns are stored in a memory of the open loop or closed loop control unit, each round wood cut pattern corresponds to a specific diameter or dimension of the round wood detected by the first scanning device.

30. The wood-machining device according to claim 29, wherein the machining gantry and the devices arranged on the processing portal trimming device, cutting device, splitting device and holding device can be moved and operated depending on the round wood cut pattern corresponding to the detected diameter or dimension.

31. A wood-machining system with a wood-machining device according to claim 1.

32. The wood-machining system according to claim 31, wherein the wood-machining system in addition to the woodworking device comprises:
a feed area for feeding round wood,
a debarking device for debarking the supplied round wood,
a wood shavings drying device,
a wood shavings compaction device,
a wood shavings container and/or
a warehouse for stacks of boards.

33. A method for machining round wood aligned along a longitudinal direction of a wood-machining device, the method comprising:
holding the round wood on a machine frame using a holding device,
moving a machining gantry in the longitudinal direction on the machine frame,
trimming the round wood by a trimming device arranged on the machining gantry during the moving of the machining gantry, the trimming device comprising at least one milling head,
cutting the round wood during the moving of the machining gantry using a cutting device arranged on the machining gantry, the cutting device comprising at least one, in particular horizontally oriented, saw, and
splitting the round wood during the moving of the machining gantry using a splitting device arranged on the machining gantry, the splitting device comprising at least one, in particular vertically oriented, saw.

34. The method according to claim 33, further comprising debarking the round wood in a debarking device-before the round wood is held by the holding device.

35. The method according to claim 33, wherein, during the trimming of the round wood, the holding device holds the round wood via holding jaws engaging on the end faces and after the round wood has been completely trimmed, the holding device is changed in such a way that the holding device holds the round wood on its lateral surfaces via at least two clamping elements that are separate from the holding jaws.
